(19) United States
(12) Patent Application Publication
(10) Pub. No.: US 2016/0196886 A1
(43) Pub. Date: Jul. 7, 2016

(54) Reactor Cooling System

(71) Applicant: HITACHI, LTD., Chiyoda-ku, Tokyo (JP)

(72) Inventors: Naoyuki ISHIDA, Tokyo (JP); Akinori TAMURA, Tokyo (JP)

(21) Appl. No.: 14/910,898

(22) PCT Filed: Aug. 9, 2013
(86) PCT No.: PCT/JP2013/071679

§ 371 Date: Feb. 8, 2016

(51) Int. Cl. G21C 15/18; G21C 15/257; G21C 17/00; G21C 13/02

(52) U.S. Cl. CPC G21C 15/18; G21C 13/02; G21C 15/257; G21C 17/002

(57) ABSTRACT

It is an object to easily perform inspection and repair of a reactor cooling system that can cool a reactor for a long time without requiring electric power. An in-vessel heat exchanger disposed in the reactor is fixed to the inner side of an upper lid of a RPV, one of through-pipes piercing through the upper lid is connected to the in-vessel heat exchanger, and the other forms a connection element on the outer side of the upper lid. According to the present invention, it is extremely easy to perform inspection and repair of the reactor cooling system that can cool the reactor for a long period without requiring electric power.

### TECHNICAL FIELD

The present invention relates to a reactor cooling system.

### BACKGROUND ART

In a nuclear power plant (e.g., a boiling-water nuclear power plant), even after an operation stop, it is necessary to supply cooling water and cool a reactor core in order to remove decay heat generated in the reactor core. Usually, after the operation stop of the nuclear power plant, a part of the cooling water in a reactor pressure vessel (RPV) is discharged to a pipe connected to the RPV, the discharged cooling water is cooled by exchanging heat with seawater in a heat exchanger connected to the pipe, and the cooled cooling water is returned to the RPV through a return pipe. In this way, after the operation stop of the nuclear power plant, the decay heat of the reactor core is allowed to escape to the seawater using the heat exchanger.

An electric pump is used for supply of the cooling water in the RPV to the heat exchanger and supply of the seawater to the heat exchanger. Electric power for driving the electric pump is necessary for the removal of the decay heat after the nuclear power plant stop. When an abnormal event of a loss of an external power supply occurs during the stop of the nuclear power plant, an emergency generator is driven for supply of electricity to the electric pump, and the removal of the decay heat during the stop of the nuclear power plant is performed.

On the other hand, assuming that, although a probability is extremely low, a loss of power supply from the outside and a multiple failure of dynamic components overlap, there has been proposed a passive cooling system that makes use of a natural force such as the gravity.

For example, JP-T-9-508700 proposes a passive cooling system that emits heat from a primary containment vessel (PCV) to the atmosphere. The passive cooling system is a system in which heat exchangers are set in the PCV and on the atmosphere side, the heat exchangers are connected by a pipe through which a coolant passes, and heat is transported making use of boiling and condensation of the coolant.

### CITATION LIST

### Patent Literature

PTL 1: JP-T-9-508700

### SUMMARY OF THE INVENTION

### Technical Problem

In PTL 1, the heat exchanger is set in the PCV. However, when the heat exchanger is set in a RPV, there are problems described below.

When heat in the RPV is transported to the outside of the RPV by the heat exchanger during power supply loss, since the coolant is sent to the heat exchanger, a pipe piercing through the RPV is necessary. It is necessary to periodically inspect the heat exchanger. When the heat exchanger is set in a RPV main body, it is necessary to provide a connecting section to the pipe, which pierces through the RPV, inside the RPV to enable detachment of the heat exchanger for inspection and repair. After reactor operation, an operator cannot enter the RPV. Therefore, it is necessary to remotely perform detachment and recovery work. Time and costs are required.

Slight condensed water is generated by a heat leak from an in-vessel heat exchanger during normal operation. If the condensed water is mixed in main steam, it is likely that heat efficiency is deteriorated.

It is an object of the present invention to easily perform inspection and repair of a reactor cooling system that can cool a reactor for a long time without requiring electric power.

### Solution to Problem

In the present invention, the in-vessel heat exchanger is fixed on the inner side of an upper lid of the RPV, one of through-pipes piecing through the upper lid is connected to the in-vessel heat exchanger and the other side forms a connection element on the outer side of the upper lid.

### Advantageous Effect of the Invention

According to the present invention, it is extremely easy to perform inspection and repair of a reactor cooling system that can cool a reactor for a long period without requiring electric power.

Problems, configurations, and effects other than those explained above are made clear by the following explanation of embodiments.

### BRIEF DESCRIPTION OF THE DRAWINGS

FIG. 1 shows an example of a passive cooling system that operates during power supply loss of a boiling-water reactor.

FIG. 2 shows an example in which an in-vessel heat exchanger is set on the inner side of an upper lid of a RPV.

FIG. 3 is an arrangement diagram of the in-vessel heat exchanger viewed from above.

FIG. 4 shows an example in which the in-vessel heat exchanger is set on the inner side of the upper lid of the RPV with a cover.

FIG. 5 shows an example in which the in-vessel heat exchanger is set on the inner side of the upper lid of the RPV with a condensed water channel.

### DESCRIPTION OF THE EMBODIMENTS

In a nuclear power plant, since decay heat is generated from a reactor core even after a stop, it is necessary to allow the decay heat to escape to a heat sink such as the atmosphere or the seawater. A cooling system provided by the present invention is a passive facility. The cooling system can cool a reactor even if power supply is lost for a long time. Embodiments for facilitating setting and maintenance of the cooling facility in the present invention are explained below.

### First Embodiment

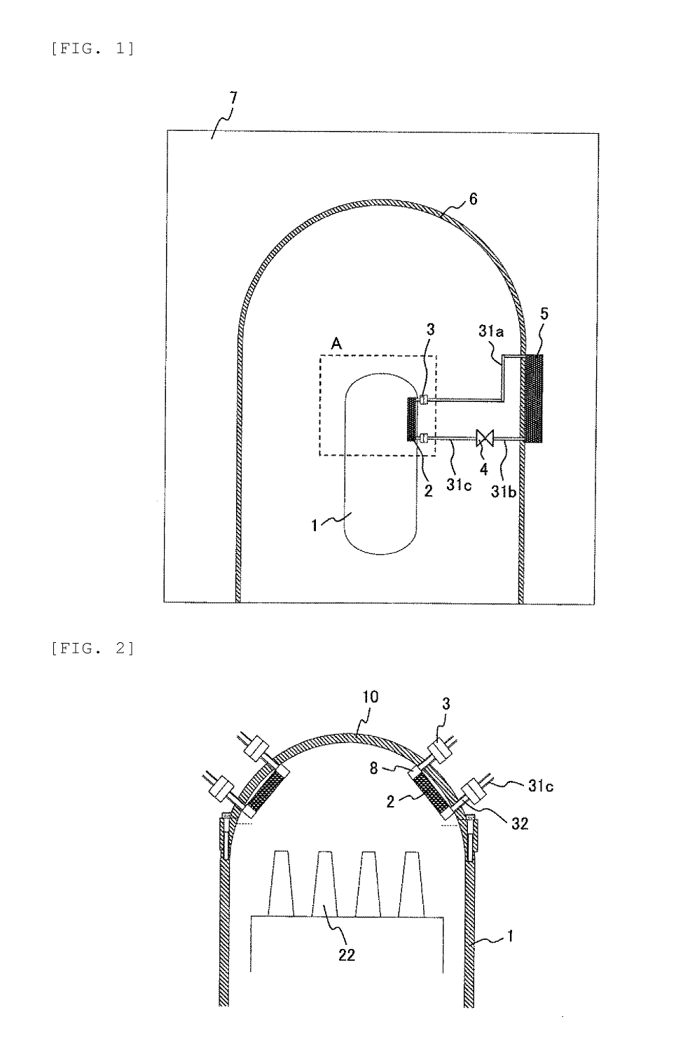

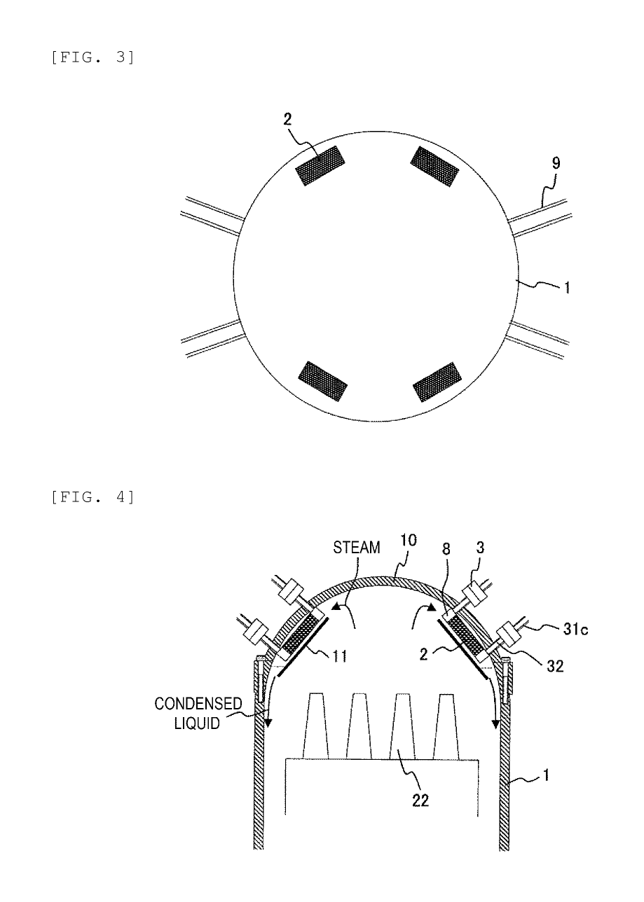

An embodiment of the present invention is explained with reference to FIG. 1 and FIG. 2.

In FIG. 1, an example of a passive cooling system that operates during power supply loss of a boiling-water reactor is shown. The cooling system is configured by an in-vessel heat exchanger 2 set in a RPV 1, an air-cooling heat exchanger 5 set on the outer side of a primary containment vessel 6, a pipe 31 that connects the in-vessel heat exchanger 2 and the air-cooling heat exchanger 5, and a valve 4 that starts the cooling system. A bottom portion of the air-cooling heat exchanger 5 is set in a position same as a bottom portion of the in-vessel heat exchanger 2 or in a position higher than the bottom portion of the in-vessel heat exchanger 2. During normal time, a coolant (e.g., water) playing a role of transporting heat in the cooling system is stored in a pipe 31b on the air-cooling heat exchanger 5 side partitioned by the valve 4.

If a power-driven cooling facility stops because of a power supply loss or the like and it is necessary to cool the reactor with the cooling facility provided by the present invention, the valve 4 is opened and the coolant is fed to the in-vessel heat exchanger 2. The coolant flowed into the in-vessel heat exchanger 2 is heated and boiled by steam in the RPV 1 to change to steam and moves to the air-cooling heat exchanger 5. In the air-cooling heat exchanger 5, the coolant is cooled by natural convection of the air to return to liquid. Since the air-cooling heat exchanger 5 is set in a position higher than the in-vessel heat exchanger 2, the coolant flows into the in-vessel heat exchanger 2 again with the gravity. In this way, after the valve 4 is opened, this cooling cycle continues without power by a natural phenomenon. The steam, from which heat is deprived by the coolant in the in-vessel heat exchanger 2, condenses to return to water and moves to the reactor core. The heat generated in the reactor core is emitted to the atmosphere in this way.

In FIG. 2, an example is shown in which the in-vessel heat exchangers 2 are set on the inner side of an upper lid 10 of the RPV 1. The in-vessel heat exchangers 2 are fixed on the inner side of the upper lid 10 by welding, flanges, or the like. The in-vessel heat exchangers 2 include a plurality of heat transfer pipes. Both ends of the heat transfer pipes are connected to headers 8. Through-pipes 32 pierce through the upper lid 10 and are connected to the headers 8 of cooling pipes of the in-vessel heat exchangers 2. On the outer side of the upper lid 10, the through-pipes 32 are connected to pipes 31c, which are connected to the air-cooling heat exchangers 5, by detachable connection elements 3 such as flanges.

During a periodical inspection, the through-pipes 32 and the pipes 31c are disconnected by the connection elements 3 and the upper lid 10 of the RPV 1 is detached. The upper lid 10 are detached from a RPV main body together with in-vessel heat exchangers 2 and stored in a work area of a reactor building 7. The in-vessel heat exchangers 2 are present in a work floor together with the upper lid 10. Therefore, an operator can perform the periodical inspection/repair during the storage with visual observation or the like while performing exposure management.

On the other hand, when the in-vessel heat exchangers 2 are connected to the RPV main body (the “RPV main body” indicates a body portion of a lower part excluding the upper lid 10 in the RPV), in order to configure a mechanism for removing only the in-vessel heat exchangers 2 from the inside of the RPV 1 for inspection/repair, it is necessary to set connection elements between the RPV 1 and the in-vessel heat exchangers 2. During the periodical inspection, the RPV 1 is submerged in order to block a radiation. Therefore, to disconnect the connection elements, a machine that performs remote operation underwater is necessary. Costs and time are required for the inspection/repair.

Therefore, the inspection/repair is remarkably facilitated by attaching the in-vessel heat exchanger to the upper lid 10 as in this embodiment.

### Second Embodiment

A second embodiment of the present invention is explained with reference to FIG. 3. FIG. 3 is an arrangement diagram of the in-vessel heat exchangers 2 viewed from above.

On heat transfer pipe surfaces of the in-vessel heat exchangers 2, steam generated in the RPV 1 is condensed, dropped by the gravity, and returned to water in the RPV. Even during normal operation in which the cooling system is not operating, a heat leak to the outside of the RPV 1 occurs a little via the in-vessel heat exchangers 2. At this point, condensed water is generated. In a steam space in the RPV 1, flows toward main steam pipes 9 are generated. When the condensed water generated by the heat leak is captured by the flows of the steam and mixed in the main steam, it is likely that heat efficiency is deteriorated a little.

Therefore, in this embodiment, with respect to the circumferential direction of the RPV 1, the in-vessel heat exchangers 2 are prevented from being disposed right above main steam pipe inlets where the main steam pipes 9 are attached to the RPV 1. That is, by setting the in-vessel heat exchanges 2 in positions shifted from right above the main steam pipe introduction ports, the condensed water generated by the heat leak is suppressed from flowing into the main steam pipes 9. Consequently, it is possible to reduce the likelihood of the heat efficiency deterioration.

### Third Embodiment

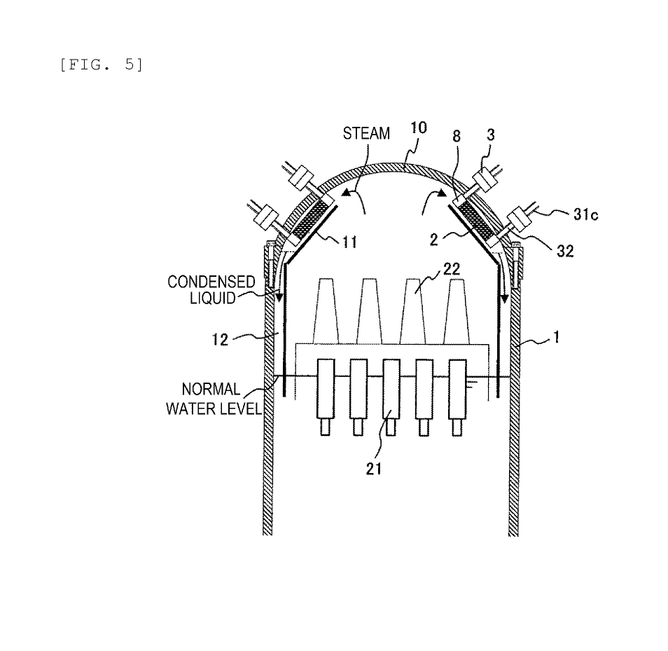

A third embodiment of the present invention is explained with reference to FIG. 4. FIG. 4 shows an example in which the in-vessel heat exchangers 2 are set on the inner side of the upper lid 10 of the RPV 1 with the cover 11.

On the heat transfer pipe surfaces of the in-vessel heat exchangers 2, the steam in the RPV 1 condenses and liquid films are generated. In condensation heat transfer, the liquid films have large heat resistance and affect a heat exchange amount. When a plurality of heat transfer pipes are set in the steam, the steam enters from gaps among the heat transfer pipes in various places. It is likely that the generated liquid films are not efficiently discharged to the outside of the heat exchangers. In this case, the liquid films having the large heat resistance tend to remain in the heat exchangers. Therefore, it is likely that a heat exchange amount of the heat exchangers decreases.

In this embodiment, covers 11 that are opened in upper and lower parts and cover side surfaces of the in-vessel heat exchangers 2 are set. With the covers 11, the steam flows along the heat transfer pipes from up to down. The steam flowed into the insides of the covers 11 from above the heat transfer pipes condenses on the heat transfer pipe surfaces. A condensed water amount increases downward and the liquid films become thicker. Inside the covers, the condensed water can be efficiently discharged from the in-vessel heat exchangers by stable steam flows flowing from up to down. It is possible to reduce the size of the in-vessel heat exchangers.

### Fourth Embodiment

A fourth embodiment of the present invention is explained with reference to FIG. 5. FIG. 5 shows an example in which the in-vessel heat exchangers 2 are set on the inner side of the upper lid 10 of the RPV 1 with the condensed water channel 12. In FIG. 5, the steam dryer 22 is set in the RPV main body and a steam separator 21 is set on the lower side of the steam dryer 22. The lower part of the steam separator 21 is located on the lower side than a normal water level.

As explained in the second embodiment, the condensed water is generated from the in-vessel heat exchangers 2 by the heat leak even during the normal operation. If the condensed water is mixed in the main steam, it is likely that the heat efficiency is deteriorated.

In this embodiment, lower outlets of the covers 11, which cover the in-vessel heat exchangers 2, are coupled to upper inlets of condensed water channels 12 attached to the main body side of the RPV 1. Lower outlets of the condensed water channels 12 are located further on the lower side than a water level in the RPV 1 during the normal operation. The condensed water generated in the in-vessel heat exchangers 2 is discharged from the in-vessel heat exchangers 2 and then flows down along the covers 11. Further, the condensed water is returned to the water through the condensed water channels 12. At this point, since the condensed water is not exposed to the steam space in the RPV, the condensed water is not mixed in the main steam. It is possible to eliminate the likelihood of the heat efficiency deterioration due to the mixing of the condensed water in the main steam.

### Fifth Embodiment

In this embodiment, setting of in-vessel heat exchangers in an existing nuclear power plant is explained. The configuration of a cooling system is the same as the configuration shown in FIG. 1 and FIG. 2.

When the in-vessel heat exchangers 2 are set in the upper lid 10 of the RPV 1, through-holes, through which the pipes 32 for feeding the coolant are inserted, are machined in the detached upper lid 10. Since the upper lid 10 is placed on the work floor, underwater work is unnecessary. The pipes 32 are inserted through the through-holes, the in-vessel heat exchangers 2 are set on the inner side of the upper lid 10, and the connection elements 3 such as flanges are attached to the pipes 32 on the outer side of the upper lid 10. The connection elements 3 are connected to the pipes 31 connected to the air-cooling heat exchangers 5 set anew. When the in-vessel heat exchangers 2 are set on the inside of the upper lid 10, it is possible to easily carry out work without requiring underwater work.

On the other hand, when the in-vessel heat exchangers 2 are set in the main body of the RPV 1, because of a reason explained below, costs increase compared with when the in-vessel heat exchangers 2 are set in the upper lid 10. First, it is necessary to machine a through-hole through which a pipe for feeding the coolant is inserted in the main body of the RPV 1. However, since a radiation is strong in the RPV after operation, the radiation needs to be blocked by water. The machining needs to be performed underwater and by remote control. The setting of the in-vessel heat exchangers and the pipes also needs to be performed underwater and by remote control. Therefore, setting costs increase.

When the passive cooling system provided by the present invention is introduced into an existing plant, it is possible to set the cooling system at low costs by applying the present invention.

Note that the present invention is not limited to the embodiments explained above. Various modifications are included in the present invention. For example, the embodiments are explained in detail in order to plainly explain the present invention. The embodiments are not always limited to embodiments including all of the explained configurations. A part of the configuration of a certain embodiment can be replaced with the configuration of another embodiment. The configuration of another embodiment can also be added to the configuration of a certain embodiment. The configuration of another embodiment can be added to, deleted from, and replaced with a part of the configurations of the embodiments.

### INDUSTRIAL APPLICABILITY

The cooling system of the present invention is applied to a nuclear power plant.

### REFERENCE SIGNS LIST

1 reactor pressure vessel RPV
2 in-vessel heat exchanger
3 connection element
4 valve
5 air-cooling heat exchanger
6 primary containment vessel (PCV)
7 reactor building
8 header
9 main steam pipe
10 upper lid
11 cover
12 condensed water channel
21 steam separator
22 steam dryer
31 pipe
32 through-pipe

1. A reactor cooling system comprising:
an in-vessel heat exchanger set in a RPV;
an air-cooling heat exchanger set on an outer side of a primary containment vessel; and
a pipe that connects the in-vessel heat exchanger and the air-cooling heat exchanger, wherein
the in-vessel heat exchanger is fixed to an inner side of an upper lid of the RPV, and one of through-pipes piercing through the upper lid is connected to the in-vessel heat exchanger and the other forms a connection element on an outer side of the upper lid.

2. The reactor cooling system according to claim 1, wherein the in-vessel heat exchanger is set in a position shifted from right above a main steam pipe inlet where a main steam pipe is attached to the RPV.

3. The reactor cooling system according to claim 1, wherein a cover that is opened in upper and lower parts and covers a side surface of the in-vessel heat exchanger is set.

4. The reactor cooling system according to claim 3, wherein a lower outlet of the cover is coupled to an upper inlet of a condensed water channel attached to a main body side of the RPV, and a lower outlet of the condensed water channel is located further on a lower side than a water level in the RPV during normal operation.
